(19) United States
(12) Patent Application Publication
(10) Pub. No.: US 2008/0270666 A1
(43) Pub. Date: Oct. 30, 2008

(54) Removable active communication bus

(76) Inventors: Christopher Gregory Malone, Loomis, CA (US); Thane M. Larson, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/796,951

(22) Filed: Apr. 30, 2007

(51) Int. Cl. G06F 13/14

(52) U.S. Cl. 710/305; 709/213

(57) ABSTRACT

A removable active communication bus of an apparatus in one example comprises at least two blade communication interfaces that are configured to communicatively couple at least two blade components within at least one blade enclosure.

### BACKGROUND

Computer systems for high performance or high-reliability applications are often part of a rack-mount system or blade system. A rack-mount system often requires a large symmetric multiprocessor (SMP) architecture built into rack-mount servers. The SMP architecture allows for high capabilities due to complex application specific integrated circuits (ASICs), crossbars between processors, and extensive cabling between the rack-mount servers.

Blade systems typically comprise a blade enclosure that houses several blade components. The blade enclosure may provide a centralized source for power, cooling, and/or communications for the blade components. This allows the blade components to be modular and specialized to a specific task, such as a server or storage unit.

### SUMMARY

The invention in one implementation encompasses an apparatus. The apparatus comprises a removable active communication bus. The removable active communication bus comprise at least two blade communication interfaces that are configured to communicatively couple at least two blade components within at least one blade enclosure.

Another implementation of the invention encompasses a method. A removable active communication bus is communicatively coupled with a first blade component. The first blade component is communicatively coupled with at least one second blade component through the removable active communication bus.

A further implementation of the invention encompasses a computer readable storage medium on which is embedded at least one computer program. The at least one computer program comprises a set of instructions for communicatively coupling a removable active communication bus with a first blade component. The at least one computer program comprises a set of instructions for communicatively coupling the first blade component with at least one second blade component through the removable active communication bus.

### DESCRIPTION OF THE DRAWINGS

Features of example implementations of the invention will become apparent from the description, the claims, and the accompanying drawings in which:

FIG. 1 is a representation of one implementation of an apparatus that comprises blade components mounted within a blade enclosure of a rack-mount frame.

FIG. 2 is a representation of one implementation of an apparatus that comprises a removable active communication bus coupled with blade components.

FIG. 3 is a representation of another implementation of an apparatus that comprises a removable active communication bus coupled with blade components and a blade enclosure.

FIG. 4 is a representation of yet another implementation of an apparatus that comprises a removable active communication bus coupled with blade components.

FIG. 5 is a representation of one implementation of a removable active communication bus of the apparatus of FIG. 2.

### DETAILED DESCRIPTION

Referring to the BACKGROUND section above, the SMP architecture requires a large initial cost for deployment and may have limited potential for future upgrades. As performance requirements increase, an entire rack-mount server may need to be replaced or “scaled up”. The blade systems can be clustered to allow a “scale-out” expansion for increased capabilities with a reduced initial cost for deployment. For example, additional blade enclosures and blade components can be added and linked via passive cables or an interconnect module. However, this approach may be limited by increased latency due to the physical distance between the blade components and the number of components that can be reliably linked to a single electrical output.

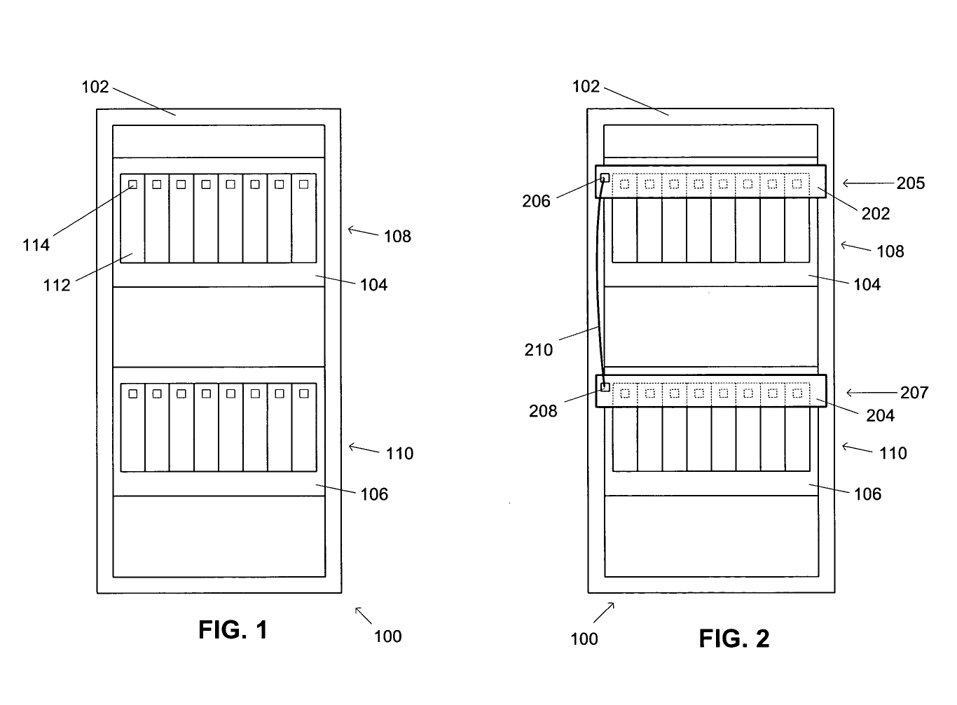

Turning to FIG. 1, an apparatus 100 in one example comprises a rack-mount chassis 102 and at least one blade enclosure, for example, blade enclosures 104 and 106. The rack-mount chassis 102 and the blade enclosures 104 and 106 in one example conform to an “EIA RS-310” standard (Electronic Industries Alliance, Arlington, Va., http://www.eia.org). For example, the rack-mount chassis 102 and the blade enclosures 104 and 106 comprise a height interval that is an integral multiple of “U” (1.75 inches), for example, “1 U”, “2 U”, “4 U”, etc. and a width of approximately 19 or 23 inches, as will be understood by those skilled in the art.

The blade enclosures 104 and 106 in one example are mounted within the rack-mount chassis 102. The blade enclosures 104 and 106 comprise a plurality of slots or bays for receiving blade components, for example, blade component 112. One or more blade components may be mounted within the blade enclosures 104 and 106 to partially or completely fill the bays. In the example of FIG. 1, a plurality of blade components 108 is mounted within the blade enclosure 104 and a plurality of blade components 110 is mounted within the blade enclosure 106 to completely fill the blade enclosures 104 and 106. The blade enclosures 104 and 106 in one example comprise passive backplanes for power and data connections to the plurality of blade components 108 and 110. Each of the plurality of blade components 108 and 110 are analogous to blade component 112, as will be appreciated by those skilled in the art.

The blade component 112 may comprise a blade server, blade storage unit, or other blade component. The blade component 112 comprises at least one communication interface 114. The communication interface 114 may be on a front face of the blade component 112, or a rear face of the blade component 112. For example, the communication interface 114 may be communicatively coupled with the passive backplane of the blade enclosure 104 upon insertion of the blade component 112. In another example, a portion of the rear face of the blade component 112 is accessible from a rear of the blade enclosure 104.

Turning to FIG. 2, an embodiment of the apparatus 100 in one example comprises the rack-mount chassis 102 and blade enclosures 104 and 106 of FIG. 1 and further comprises at least one removable active communication bus, for example, removable active communication buses 202 and 204. The removable active communication bus 202 in one example comprises at least two blade communication interfaces 205 to communicatively couple at least two blade components, as described herein. In a further example, the removable active communication bus 202 comprises at least one bus communication interface 206. The removable active communication bus 204 is analogous to the removable active communication bus 202, as will be appreciated by those skilled in the art. For example, the removable active communication bus 204 comprises at least two blade communication interfaces 207 and at least one bus communication interface 208.

The removable active communication buses 202 and 204 communicatively couple at least two blade components of the plurality of blade components 108 and 110. In a first example, the removable active communication bus 202 communicatively couples at least two of the plurality of blade components 108, for example, through the blade communication interfaces 205. In a second example, the removable active communication bus 202 is communicatively coupled with the removable active communication bus 204 through a communication link 210 between the bus communication interfaces 206 and 208. In this example, the removable active communication buses 202 and 204 cooperate to communicatively couple at least two of the plurality of blade components 108 and 110. Examples of communication links comprise twisted pair cables, fiber optic cables, coaxial cables, parallel cables, and serial cables.

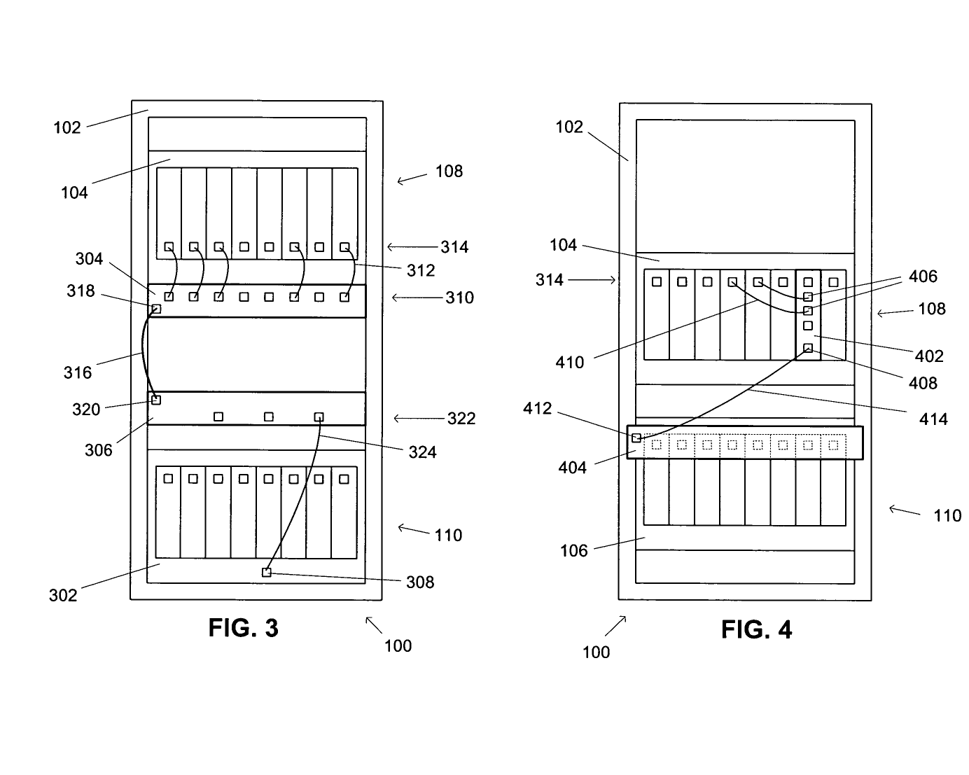

Turning to FIG. 3, another embodiment of the apparatus 100 in one example comprises the rack-mount chassis 102 and blade enclosure 104 of FIG. 1 and further comprises a blade enclosure 302 and at least one removable active communication bus, for example, removable active communication buses 304 and 306. The blade enclosure 302 is analogous to the blade enclosures 102 and 104 but further comprises at least one communication interface 308. For example, the communication interface 308 may provide an external interface to the passive backplane and/or the plurality of blade components 110 within the blade enclosure 302.

The removable active communication bus 304 in one example comprises at least one blade communication interface, for example, blade communication interfaces 310. The removable active communication bus 304 is communicatively coupled with the plurality of blade components 108 through one or more communication links 312 between the blade communication interfaces 310 and communication interfaces 314 (analogous to communication interface 114, FIG. 1). The removable active communication bus 304 in one example is communicatively coupled with the removable active communication bus 306 through a communication link 316 between bus communication interfaces 318 and 320.

The removable active communication bus 306 in one example comprises at least one blade communication interface 322 that is communicatively coupled with the communication interface 308 of the blade enclosure 302 through a communication link 324. This allows the removable active communication bus 306 to communicate with the plurality of blade components 110 within the blade enclosure 302, for example, through the passive backplane of the blade enclosure 302.

Turning to FIG. 4, yet another embodiment of the apparatus 100 in one example comprises the rack-mount chassis 102 and blade enclosures 104 and 106 of FIG. 1 and further comprises at least one removable active communication bus, for example, removable active communication buses 402 and 404. The removable active communication bus 402 in one example comprises a blade component that is mounted within the blade enclosure 104. The removable active communication bus 402 comprises at least one blade communication interface 406 and at least one bus communication interface 408. One or more communication links 410 communicatively couple the removable active communication bus 402 with the plurality of blade components 108 through the blade communication interfaces 406 and the communication interfaces 314 of the plurality of blade components 108. The removable active communication bus 404 in one example is analogous to the removable active communication bus 204. A bus communication interface 412 of the removable active communication bus 404 is communicatively coupled with the bus communication interface 408 by communication link 414.

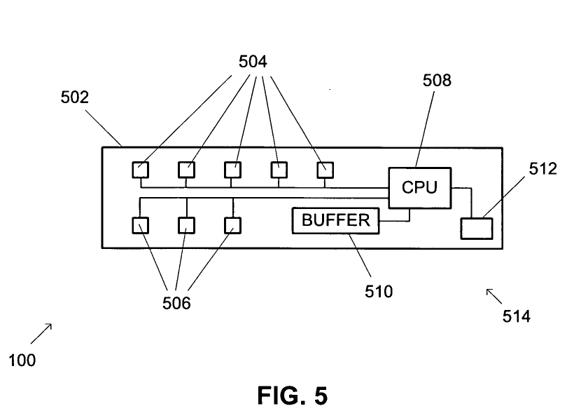

Turning to FIG. 5, a removable active communication bus 502 in one example serves to communicatively couple at least two blade components. In a further example, the removable active communication bus 502 communicatively couples a first blade component with at least two second blade components. For example, the removable active communication bus 502 is analogous to removable active communication buses 202, 204, 304, 306, 402, and 404. The removable active communication bus 502 in one example comprises at least one blade communication interface 504. In a further example, the removable active communication bus 502 comprises at least one bus communication interface 506. The removable active communication bus 502 in one example comprises at least one central processing unit (CPU) 508 and at least one buffer 510. In a further example, the removable active communication bus 502 comprises an instance of a recordable data storage medium 512, as described herein. One or more of the communication interfaces 504 and 506, the CPU 508, the buffer 510, and the recordable data storage medium 512 in one example are coupled by a printed circuit board 514.

The blade communication interfaces 504 allow for communication with blade components 112 through communication interface 114 (FIG. 1) or through blade enclosures 302 via communication interface 308 (FIG. 3). The removable active communication bus 502 in one example comprises a crossbar switch. For example, the removable active communication bus 502 may couple or provide a communication path between one or more of a processor, memory, and storage unit of the blade components and allow separate blade components to share their memory and/or processor resources. In one example, the removable active communication bus 502 allows for shared coherent memory access between the blade components. The buffer 510 in one example is employable to buffer communications between the blade components, which may reduce or control timing delays and accordingly increase a distance at which blade components can be coupled. The bus communication interfaces 506 allow for communication with other removable active communication buses. Accordingly, a message received from a first blade component may be passed through to another removable active communication bus and then to a second blade component.

The CPU 508 in one example processes communications between the blade communication interfaces 504 and the bus communication interfaces 506. For example, the removable active communication bus 502 comprises a removable active backplane. In another example, the CPU 508 manages the blade communication interfaces 504, the bus communication interfaces 506, and the buffer 510. The CPU 508 in one example provides a virtualized interface to a blade component or a plurality of blade components. For example, the blade component 112 may view a communication link to the removable active communication bus 502 as a single endpoint. The CPU 508 may handle duplication or modification of communications sent to the endpoint, for example, to provide a broadcast of communications to a plurality of other blade components. The CPU 508 in one example receives instructions from the recordable data storage medium 512 or another removable active communication bus.

The removable active communication bus 502 in one example is dynamically configurable. For example, communicative couplings, interfaces, and resources managed by the removable active communication bus 502 may be dynamically configured. In a first example, the removable active communication bus 502 provides dynamic configuration of virtualization of the interfaces 504 and 506. In a second example, the removable active communication bus 502 provides dynamic configuration of communicative coupling between the blade components, for example, to provide availability in case of a failure in a communication link. In a third example, the removable active communication bus 502 provides dynamic configuration of redundancy of the communicative coupling between the blade components. In a fourth example, the removable active communication bus 502 provides dynamic configuration of security of the communicative coupling between the blade components.

In the embodiment of FIG. 2, the removable active communication buses 202 and 204 are mounted onto the rack-mount chassis 102, for example, onto a rear face of the rack-mount chassis 102. In an alternative embodiment, the removable active communication buses 202 and 204 may be mounted to another face of the rack-mount chassis 102, for example a front face or side face. In yet another embodiment, the removable active communication buses 202 and 204 may be mounted to the blade enclosure 104 and 106 and/or the individual blade components of the plurality of blade components 108 and 110. In the embodiment of FIG. 3, the removable active communication bus 302 and 304 comprise a rack-mount form factor and are mounted within the rack-mount chassis 102 as a piece of rack-mount equipment. In the embodiment of FIG. 4, the removable active communication bus 402 comprises a blade component that is mounted within the blade enclosure 104. Alternative orientations and configurations will be apparent to those skilled in the art. For example, a removable active communication bus may be coupled with an interconnect module of a blade enclosure.

The apparatus 100 in one example comprises a plurality of components such as one or more of electronic components, hardware components, and computer software components. A number of such components can be combined or divided in the apparatus 100. An example component of the apparatus 100 employs and/or comprises a set and/or series of computer instructions written in or implemented with any of a number of programming languages, as will be appreciated by those skilled in the art.

The apparatus 100 in one example employs one or more computer-readable signal-bearing media. The computer-readable signal-bearing media store software, firmware and/or assembly language for performing one or more portions of one or more implementations of the invention. Examples of a computer-readable signal-bearing medium for the apparatus 100 comprise the recordable data storage medium 512 of the removable active communication bus 502. The computer-readable signal-bearing medium for the apparatus 100 in one example comprise one or more of a magnetic, electrical, optical, biological, and atomic data storage medium. For example, the computer-readable signal-bearing medium comprise floppy disks, magnetic tapes, CD-ROMs, DVD-ROMs, hard disk drives, and electronic memory.

The steps or operations described herein are just for example. There may be many variations to these steps or operations without departing from the spirit of the invention. For instance, the steps may be performed in a differing order, or steps may be added, deleted, or modified.

Although example implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. An apparatus, comprising:
a removable active communication bus that comprises at least two blade communication interfaces that are configured to communicatively couple at least two blade components within at least one blade enclosure.

2. The apparatus of claim 1, wherein the removable active communication bus comprises a removable active backplane that is dynamically configurable.

3. The apparatus of claim 1, wherein the removable active communication bus is configured to provide a shared coherent memory area to the at least two blade components.

4. The apparatus of claim 1, wherein the at least two blade components comprise a first blade component and a plurality of second blade components;
wherein the at least two blade communication interfaces comprise a virtualized interface to the plurality of second blade components;
wherein the removable active communication bus provides to the first blade component the virtualized interface to the plurality of second blade components.

5. The apparatus of claim 1, wherein the removable active communication bus comprises a printed circuit board with at least one processor;
wherein the printed circuit board is configured to couple the at least one processor with the at least two blade communication interfaces.

6. The apparatus of claim 1, wherein the removable active communication bus comprises at least one buffer for communications between the at least two blade components.

7. The apparatus of claim 1, wherein the removable active communication bus comprises a crossbar switch that provides the at least two blade communication interfaces.

8. The apparatus of claim 1, wherein the removable active communication bus is configured to provide a communication path between central processing units (CPUs) of the at least two blade components.

9. The apparatus of claim 1, wherein the at least two blade components comprise a blade component, wherein the at least two blade communication interfaces comprise a blade communication interface;
wherein the blade communication interface is coupled with one of:
a communication interface of the blade component; and
a communication interface of the at least one blade enclosure that contains the blade component.

10. The apparatus of claim 1, wherein the removable active communication bus comprises a first removable active communication bus;
the apparatus further comprising a second removable active communication bus;
wherein the first removable active communication bus comprises at least one bus communication interface that is configured to communicatively couple the first removable active communication bus with the second removable active communication bus;
wherein the first removable active communication bus is communicatively coupled with the second removable active communication bus through a bus communication interface of the first removable active communication bus and a bus communication interface of the second removable active communication bus;
wherein the first removable active communication bus is coupled with a first set of blade components of the at least two blade components;
wherein the second removable active communication bus is coupled with a second set of blade components;
wherein the first and second removable active communication buses cooperate to allow communication between the first and second sets of blade components.

11. The apparatus of claim 1, wherein the removable active communication bus is mounted to a rack-mount chassis.

12. The apparatus of claim 11, wherein the removable active communication bus is mounted adjacent to a rear face of the rack-mount chassis.

13. The apparatus of claim 11, wherein the removable active communication bus comprises a rack-mount form factor and is mounted within the rack-mount chassis.

14. The apparatus of claim 1, wherein the removable active communication bus comprises a blade component that is mounted to a blade enclosure of the at least one blade enclosure.

15. A method, comprising the steps of:
communicatively coupling a removable active communication bus with a first blade component; and
communicatively coupling the first blade component with at least one second blade component through the removable active communication bus.

16. The method of claim 15, wherein the step of communicatively coupling the removable active communication bus with the first blade component comprises one of:
communicatively coupling a first blade communication interface of the removable active communication bus with the first blade component; and
communicatively coupling the first blade communication interface of the removable active communication bus with a blade enclosure that contains the first blade component.

17. The method of claim 16, wherein the removable active communication bus comprises a first removable active communication bus, wherein the step of communicatively coupling the first blade component with the second blade component through the removable active communication bus comprises one of:
communicatively coupling a second blade communication interface of the removable active communication bus with the second blade component;
communicatively coupling the second blade communication interface of the removable active communication bus with a blade enclosure that contains the second blade component; and
communicatively coupling a bus communication interface of the first removable active communication bus with a bus communication interface of a second removable active communication bus, communicatively coupling a first blade communication interface of the second removable active communication bus with the second blade component, and communicatively coupling the first blade communication interface of the second removable active communication bus with a blade enclosure that contains the second blade component.

18. The method of claim 15, further comprising the step of:
dynamically configuring the removable active communication bus for at least one of:
virtualization of at least one blade communication interface of the removable active communication bus;
virtualization of at least one bus communication interface of the removable active communication bus;
communicative coupling between any of the first blade component and the at least one second blade component;
redundancy of the communicative coupling between any of the first blade component and the at least one second blade component; and
security of the communicative coupling between any of the first blade component and the at least one second blade component.

19. A computer readable storage medium on which is embedded at least one computer program comprising a set of instructions for:
communicatively coupling a removable active communication bus with a first blade component; and
communicatively coupling the first blade component with at least one second blade component through the removable active communication bus.

20. The computer readable storage medium of claim 19, wherein the at least one computer program comprises a set of instructions for:
dynamically configuring the removable active communication bus for at least one of:
virtualization of at least one blade communication interface of the removable active communication bus;
virtualization of at least one bus communication interface of the removable active communication bus;
communicative coupling between any of the first blade component and the at least one second blade component;
redundancy of the communicative coupling between any of the first blade component and the at least one second blade component; and
security of the communicative coupling between any of the first blade component and the at least one second blade component.
